(19) United States
(12) Patent Application Publication
(10) Pub. No.: US 2008/0235340 A1
(43) Pub. Date: Sep. 25, 2008

(54) Information processing device, information processing method and information processing program

(75) Inventors: Takeshi Kumazawa, Kawasaki (JP); Yasuo Sugahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/071,405

(22) Filed: Feb. 20, 2008

(30) Foreign Application Priority Data
Mar. 19, 2007 (JP) JP2007-070603

(51) Int. Cl. G06F 15/16

(52) U.S. Cl. 709/206

(57) ABSTRACT

Included are a browse determining unit 9 determining whether or not a user to whom an electronic mail is addressed browses information of the delivered electronic mail by referring to a user information storage unit 6 stored with at least an electronic mail address of the user in information about the registered user, and a Web page providing unit 10 receiving an access from the user determined by the browse determining unit 9 not to have browsed the information of the electronic mail, and providing a Web page containing the information of the electronic mail to the user.

This application claims the benefit of Japanese Patent Application No. JP2007-070603 filed on Mar. 19, 2007 in the Japanese Patent Office, the disclosure of which is herein incorporated in its entirety by reference.

### BACKGROUND OF THE INVENTION

An information processing device, an information processing method and an information processing program are illustrated.

Nowadays, various categories of information are distributed from Websites on the Internet. Some of these Websites are opened to unspecified users, and some are opened to specified users. In the case of accessing the Website opened to the specified users, the user logs in after making user registration, and browses a desired Web page. An information provider, who operates the Website, in the case of desiring to transmit the information to the users, describes the information on the Website and sends the information by mail to the registered users.

If the registered user changes a mail address, the information distributor gets unable to send the information by e-mail to the registered user. For example, Patent document 1 describes a technology of displaying, if the e-mail transmitted to the registered user does not reach, a message prompting the registered user to change the registered mail address when this registered user accesses the Website. Further, Patent document 2 describes a technology of sending, in a system for receiving an order of and forwarding a gift product on the Internet, an announcement by mailing a postcard if a gift recipient does not have an e-mail address. Moreover, Patent document 3 describes a technology of transmitting, if there is not any access from a mail recipient after a fixed period of time elapses since the mail has been transmitted, the mail again to this mail recipient.

[Patent document 1] Japanese Patent Laid-Open Publication No. 2001-337892

[Patent document 2] Japanese Patent Laid-Open Publication No. 2002-24584

[Patent document 3] Japanese Patent Laid-Open Publication No. 2001-297165

### SUMMARY OF THE INVENTION

Those technologies have, however, the following problems. To be specific, according to the technologies given above, if the e-mail and the postcard do not reach or are discarded mistakenly, the information distributed by the information distributor is not browsed by the user, in which case the information distributor misses a chance of providing the information to the user, while the user misses a chance of acquiring the useful information from the information distributor.

Such being the case, it is an object to provide an information processing device, an information processing method and an information processing program each capable of notifying the user of information described in the e-mail even when the user does not browse the e-mail.

The present, in order to solve the problems given above, provides a Web page containing the information of the e-mail to the user when the Website is accessed by the user at whom the e-mail does not arrive.

Specifically, an information processing device comprises: a browse determining unit determining whether or not a user to whom an electronic mail is addressed browses information of the delivered electronic mail by referring to a user information storage unit stored with at least an electronic mail address of the user in information about the registered user; and a Web page providing unit receiving an access from the user determined by the browse determining unit not to have browsed the information of the electronic mail, and providing a Web page containing the information of the electronic mail to the user.

The information processing device according to the present includes the Web page providing unit that provides the Web page to the user having the access via the network. A service provider etc, who operates the information processing device, gets the user information storage unit defined as a recording medium stored with the information on the registered user.

Herein, the Website (an aggregation of Web pages) serves to provide the information through bidirectional communications with users. Hence, it can be checked by knowing if there is an access from the user whether the user browses the information described on the Web page or not. On the other hand, the electronic mail serves to provide the information through unidirectional communications with the users. It can not be therefore checked simply by delivering the e-mail whether the user recognizes the information described in the e-mail or not.

Such being the case, the information processing device according to the present includes the browse determining unit. The browse determining unit determines whether the user to whom the e-mail is addressed browses the delivered e-mail or not. It can be thereby checked whether the user recognizes the information of the e-mail or not.

The Web page providing unit, when receiving the access from the user determined by the browse determining unit not to have browsed the information of the e-mail, provides this user with the Web page containing the information attached to the e-mail. This scheme enables the user to acquire the information of the e-mail without any missing pieces of information.

The scheme described above enables the user to be notified of the information described in the e-mail even when the e-mail is not browsed by the user.

Further, the browse determining unit may, if applied to at least any one of a case where the user accesses a link destination attached to the delivered electronic mail and a case where Message Disposition Notification is sent from the address of the delivered electronic mail, determine that the user receiving the electronic mail has browsed the information of the electronic mail.

According to this scheme, it is possible to determine whether the user checks the delivered e-mail or not.

Still further, the Web page providing unit may, when receiving the access from the user determined by the browse determining unit to have browsed the information of the electronic mail, provides the user with a Web page containing none of the information of the electronic mail.

According to this scheme, the information, which has already been provided by the e-mail, is not again provided on the Web page, and hence the information processing can be efficiently done.

Yet further, the information processing device may further comprise a mail delivering unit referring to the user information storage unit and delivering the information by the electronic mail addressed to the electronic mail address stored in the user information storage unit, wherein the mail delivering unit may, after delivering the electronic mail, get the user information storage unit further stored with transmission record information defined as a record of delivering the electronic mail on a user-by-user basis, the browse determining unit may, when determining that the user has browsed the information of the electronic mail, erase the transmission record information of the user, which is stored in the user information storage unit, and the Web page providing unit may, when the user accesses a Web page, check existence or non-existence of the transmission record information of the user by referring to the user information storage unit, and may provide the user with the Web page containing the information of the electronic mail when judging that the browse determining unit determines, after searching for the transmission record information from within the user information storage unit, that the user does not browse the information of the electronic mail.

Moreover, the present disclosure may also be an information processing method by which any one of the functions described above is carried out. Further, the present disclosure may also be an information processing program that makes a computer execute any one of the functions described above. Yet further, the present disclosure may also be a readable-by-computer recording medium recorded with the information processing program.

The user can be notified of the information described in the e-mail even when the e-mail is not browsed by the user.

### BRIEF DESCRIPTION OF THE DRAWINGS

FIG. 1 is a diagram of a whole configuration of a Web server;

FIG. 2 is a flowchart of processes by the Web server; and

FIG. 3 is a diagram of a whole configuration of an information processing device according to a modified example.

### DETAILED DESCRIPTION OF THE INVENTION

An information processing device, an information processing method and an information processing program according to a preferred embodiment will hereinafter be described with reference to the drawings. A configuration in the following embodiment is an exemplification, and the present disclosure is not limited to the configuration in the embodiment.

<Configuration>

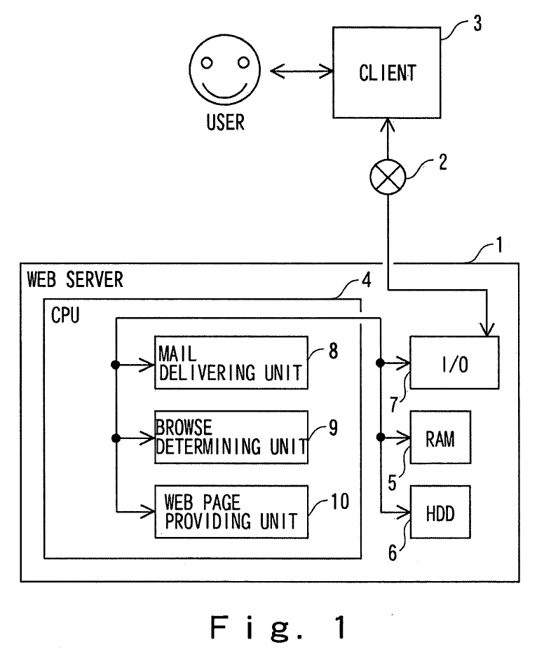

FIG. 1 is a diagram of a whole configuration, showing a Web server 1 according to the present embodiment, a communication network 2 connected to the Web server 1, and a client 3 connected to the communication network 2. As illustrated in FIG. 1, the Web server 1 has a communication-enabled configuration with the client 3 via the communication network 2. The Web server 1 is a server computer operated by an information provider who provides various categories of information services, and is installed in an office building etc of a company of the information provider. The communication network 2 is a computer network using TCP/IP (Transmission Control Protocol/Internet Protocol) protocol. The client 3 is a personal computer possessed by a user, and is installed in a house etc of the user. Note that the embodiment is based on such a premise that the client 3 is a personal computer, however, the present disclosure is not limited to the personal computer and may also be, for example, a mobile phone and a portable information terminal such as a PDA (Personal Digital Assistant) each including a WWW Browser. Further, an assumption in FIG. 1 is that though only one client 3 is illustrated, an infinite number of clients 3 are connected to the communication network 2.

The Web server 1 constructed of a CPU (Central Processing Unit) 4, a memory 5, a hard disk 6 and an input/output interface 7. The CPU 4 executes an information processing program stored in the hard disk 6 etc, and cooperates in function with the memory 5 and the input/output interface 7, thereby realizing a mail delivering unit 8, a browse determining unit 9 and a Web page providing unit 10.

The hard disk 6 defined as a recording medium is stored with information on electronic mail addresses of users registered in an information providing service provided by the information provider. Note that the information stored in the hard disk 6 is not limited to only the information on the e-mail addresses of the users but may include information on a browsing history of Web pages browsed by the user, information on a log-in ID and a log-in password, information on a credit card number when conducting an electronic settlement, and information on an address, an age, a favorite, etc. It is to be noted that the hard disk 6 is stored with the information such as the e-mail address of the user in the embodiment, however, the present disclosure is not limited to this mode, and, for example, the information may be stored in a database server etc connected to the outside.

The mail delivering unit 8 delivers the e-mail to the client 3 via the communication network 2. The mail delivering unit 8 is so configured as to be enabled to acquire the user's e-mail address stored in the hard disk 6, and to transmit the e-mail addressed to the acquired e-mail address. The mail delivering unit 8, after transmitting the e-mail, gets the hard disk 6 stored with transmission record information containing items of information on transmission time, a destination (recipient) and a content of the transmission of the transmitted e-mail. Note that the mail delivering unit 8 may also get the transmission record information stored on a recording medium (such as the database server connected to the outside) other than the hard disk 6. The mail delivering unit 8 delivers the e-mail to the client 3 via the input/output interface 7 and the communication network 2.

The browse determining unit 9 determines whether or not the user has browsed the e-mail address delivered by the mail delivering unit 8. A scheme in the embodiment is that the browse determining unit 9, if applied to any one of a case where the user has accessed a link destination (Web page) attached to the e-mail delivered by the mail delivering unit 8 and a case where Message Disposition Notification (MDN) is sent back from the recipient of the e-mail delivered by the mail delivering unit 8, determines that the user has browsed the e-mail delivered by the mail delivering unit 8. The browse determining unit 9 monitors a state of the access to the Web page providing unit 10, and acquires the information on the client 3 accessing the page of the link destination attached to the e-mail, thereby detecting whether the user accesses the link destination or not. Further, the browse determining unit 9 monitors the e-mail sent from the client 3 via the input/output interface 7 and the communication network 2, thereby monitoring whether the Message Disposition Notification is given from the client 3 or not.

Note that if the e-mail delivered by the mail delivering unit 8 is sent back due to an address error, or if neither the user's access to the link destination attached to the delivered e-mail nor the transmission of the Message Disposition Notification was done even when a fixed period of time (which is a time interval for the user to check the e-mail, e.g., 24 hours) elapses since the mail delivering unit 8 has delivered the e-mail, the browse determining unit 9 may determine that the user does not browse the e-mail delivered by the mail delivering unit 8.

The Web page providing unit 10 transmits data of the Web page to the client 3 accessing the Web server 1. The Web page describes various categories of contents provided by the information provider. The Web page providing unit 10 is so configured as to be enabled to change the information described on the Web page, corresponding to a result of the determination by the browse determining unit 9. Namely, the Web page providing unit 10, if there is an access from the user determined by the browse determining unit 9 not to have browsed the information of the e-mail, transmits the Web page containing the information of the e-mail delivered by the mail delivering unit 8 to this user. Note that the Web page providing unit 10, if there is the access from the user determined by the browse determining unit 9 to have browsed the information of the e-mail, transmits the Web page containing none of the information of the e-mail delivered by the mail delivering unit 8 to this user. The Web page providing unit 10, when the client 3 accesses the Web server 1, searches the data in the hard disk 6 and thus inquires about existence or non-existence of the transmission record information on this client 3. The Web page providing unit 10, after searching for the transmission record information on the client 3, judges that the browse determining unit 9 determines that this client 3 does not browse the information of the e-mail. The Web page providing unit 10, on the occasion of transmitting the Web page to the client 3, transmits the data via the input/output interface 7 and the communication network 2.

<Processing Flow>

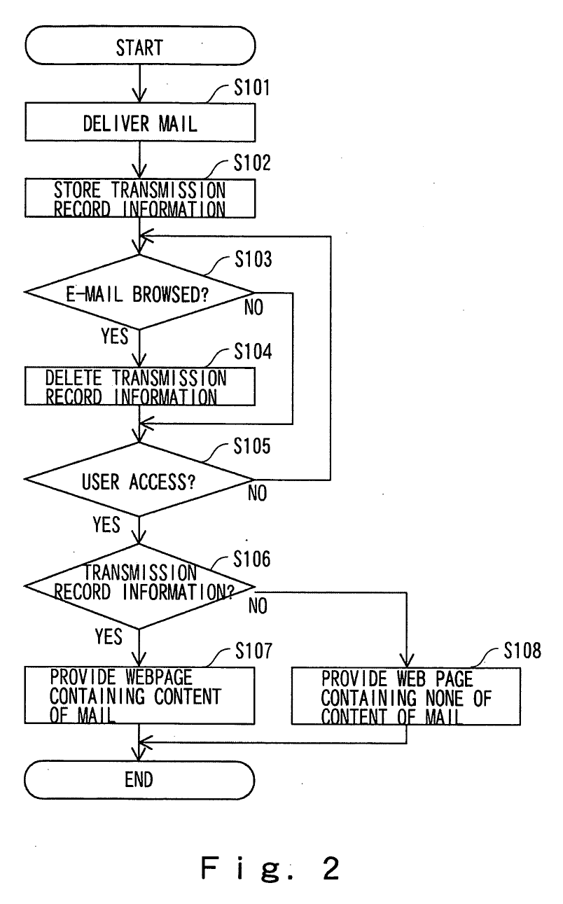

Next, a processing flow of the Web server 1 according to one embodiment of the information processing method of the present disclosure will be described. FIG. 2 is a flowchart of the processes by the Web server 1. An information processing flow of the Web server 1 will hereinafter be explained with reference to the flowchart in FIG. 2.

To begin with, the mail delivering unit 8 delivers, to the client 3, an e-mail describing information on an announcement of a new product etc (step S101). A content of the e-mail is created by the information provider etc who operates the Web server 1. The mail delivering unit 8, on the occasion of delivering the e-mail, refers to the user's e-mail address stored in the hard disk 6, and delivers the e-mail addressed to this e-mail address.

The mail delivering unit 8, after delivering the e-mail to the client 3, stores the transmission record information in the hard disk 6 (step S102).

Next, the browse determining unit 9 determines whether or not the user checks the e-mail delivered by the mail delivering unit 8 (step S103).

The browse determining unit 9, when determining that the user browses the e-mail, deletes the transmission record information on this user, which is stored in the hard disk 6, and moves to step S105 (step S104). While on the other hand, the browse determining unit 9, when determining that the user does not browse the e-mail, diverts to step S105 in a way that skips step S104.

The Web page providing unit 10 checks whether there is the access from the user or not (step S105). The Web page providing unit 10, if there is no access from the user, gets the browse determining unit 9 to again check whether the e-mail is browsed (step S103). Whereas if there is the access from the user, the Web page providing unit 10 moves to step S106.

The Web page providing unit 10, if there is the access from the user, searches the data in the hard disk 6 and thus checks the existence and non-existence of the transmission record information associated with the user having the access (step S106).

The Web page providing unit 10, when searching for the transmission record information in step S106, judges that the user having the access does not browse the e-mail delivered by the mail delivering unit 8, and transmits the data of the Web page containing the information described in the e-mail to this user (step S107).

While on the other hand, the Web page providing unit 10, when searching for none of the transmission record information in step S106, judges that the user having the access has already browsed the e-mail delivered by the mail delivering unit 8, and transmits the information described in the e-mail to this user (step S108).

<Effects>

The scheme described above enables the Web server 1 according to one embodiment to provide the user with the information described in the e-mail even if the e-mail delivered by the mail delivering unit 8 does not reach or is not opened.

Note that the Web page providing unit 10 may transmit the Web page in a way that gets the Web page to contain only a digest of the information descried in the e-mail and may also transmit the Web page that emphasizes the information described in the e-mail by color-sorting etc. According to this scheme, the user can easily recognize the information described in the e-mail from within the information on the Web page.

Further, the Web page providing unit 10 grasps a favorite of the user from the Web page etc accessed frequently by the user, and may transmit the Web page in the way of making the Web page contain only the information of the e-mail matching with the favorite of the user. This scheme prevents the information matching with the favorite of the user from being displayed on the Web page.

Moreover, the Web page providing unit 10, if the e-mail delivered by the mail delivering unit 8 results in an error due to an unknown address, may send a message that prompts the user having the access to re-register the mail address and a Web page including a menu screen. The information of the mail address stored in the hard disk 6 is updated, whereby the e-mail delivered by the mail delivering unit 8 delivered by the mail delivering unit 8 is sent to the client 3.

### MODIFIED EXAMPLE

The Web server according to the embodiment discussed above includes all of the mail delivering unit 8, the browse determining unit 9, the Web page 10 and the hard disk 6 stored with the e-mail address of the user, the browse history of the Web pages browsed by the user, etc. The present disclosure is not, however, limited to these components.

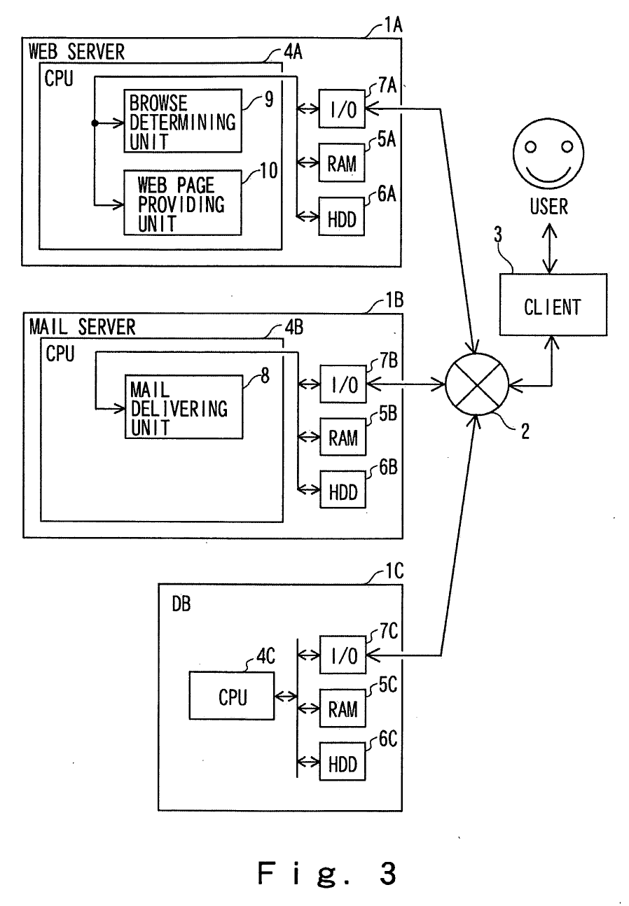

FIG. 3 illustrates a modified example. As illustrated in FIG. 3, the information processing device is constructed of a Web server 1A, a mail server 1B and a database 1C. The Web server 1A includes the browse determining unit 9 and the Web page providing unit 10, which handle the same functions as those in the embodiment discussed above. Further, the mail server 1B includes the mail delivering unit 8 that handles the same function as in the embodiment discussed above. Still further, the database 1C has the same information stored in the hard disk 6C as the information stored in the hard disk 6 according to the embodiment discussed above. Note that the Web server 1A, the mail server 1B and the database 1C include input/output interfaces 7A, 7B, 7C, memories 5A, 5B, 5C and hard disks 6A, 6B, 6C, which are the same components as in the embodiment discussed above.

The browse determining unit 9 and the Web page providing unit 10 of the Web server 1A and the mail delivering unit 8 of the mail server 1B mutually transfer and receive the data via the input/output interfaces 7A, 7B and the communication network 2, thereby realizing the same functions as those of the Web server 1 according to the embodiment discussed above.

Thus, the information processing device is not limited to the device including all the components within one single server, but may be, as in the present modified example, the device of which the components are distributed to the plurality of servers and the database.

<Readable-by-Computer Recording Medium>

A program for making a computer, other machines and devices (which will hereinafter be referred to as the computer etc) realize any one of the functions can be recorded on a recording medium readable by the computer etc. Then, the computer etc is made to read and execute the program on this recording medium, whereby the function thereof can be provided.

Herein, the recording medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a DAT, an 8 mm tape, a memory card, etc are given as those removable from the computer.

Further, a hard disc, a ROM (Read-Only Memory), etc are given as the recording mediums fixed within the computer etc.

What is claimed is:

1. An information processing device comprising:
a browse determining unit determining whether or not a user to whom an electronic mail is addressed browses information of the delivered electronic mail by referring to a user information storage unit stored with at least an electronic mail address of the user in information about the registered user; and
a Web page providing unit receiving an access from the user determined by the browse determining unit not to have browsed the information of the electronic mail, and providing a Web page containing the information of the electronic mail to the user.

2. The information processing device according to claim 1, wherein the browse determining unit, if applied to at least any one of a case where the user accesses a link destination attached to the delivered electronic mail and a case where Message Disposition Notification is sent from the address of the delivered electronic mail, determines that the user receiving the electronic mail has browsed the information of the electronic mail.

3. The information processing device according to claim 1, wherein the Web page providing unit, when receiving the access from the user determined by the browse determining unit to have browsed the information of the electronic mail, provides the user with a Web page containing none of the information of the electronic mail.

4. The information processing device according to claim 1, further comprising a mail delivering unit referring to the user information storage unit and delivering the information by the electronic mail addressed to the electronic mail address stored in the user information storage unit.

5. The information processing device according to claim 1, further comprising a mail delivering unit referring to the user information storage unit and delivering the information by the electronic mail addressed to the electronic mail address stored in the user information storage unit,
wherein the mail delivering unit, after delivering the electronic mail, gets the user information storage unit further stored with transmission record information defined as a record of delivering the electronic mail on a user-by-user basis,
the browse determining unit, when determining that the user has browsed the information of the electronic mail, erases the transmission record information of the user, which is stored in the user information storage unit, and
the Web page providing unit, when the user accesses a Web page, checks existence or non-existence of the transmission record information of the user by referring to the user information storage unit, and provides the user with the Web page containing the information of the electronic mail when judging that the browse determining unit determines, after searching for the transmission record information from within the user information storage unit, that the user does not browse the information of the electronic mail.

6. An information processing method comprising:
a browse determining step of determining whether or not a user to whom an electronic mail is addressed browses information of the delivered electronic mail by referring to a user information storage unit stored with at least an electronic mail address of the user in information about the registered user; and
a Web page providing step of receiving an access from the user determined in the browse determining step not to have browsed the information of the electronic mail, and providing a Web page containing the information of the electronic mail to the user.

7. The information processing method according to claim 6, wherein the browse determining step includes, if applied to at least any one of a case where the user accesses a link destination attached to the delivered electronic mail and a case where Message Disposition Notification is sent from the address of the delivered electronic mail, determining that the user receiving the electronic mail has browsed the information of the electronic mail.

8. The information processing method according to claim 6, further comprising a mail delivering step of referring to the user information storage unit and delivering the information by the electronic mail addressed to the electronic mail address stored in the user information storage unit,
wherein the mail delivering step includes, after delivering the electronic mail, getting the user information storage unit further stored with transmission record information defined as a record of delivering the electronic mail on a user-by-user basis,
the browse determining step includes, when determining that the user has browsed the information of the electronic mail, erasing the transmission record information of the user, which is stored in the user information storage unit, and
the Web page providing step includes, when the user accesses a Web page, checking existence or non-existence of the transmission record information of the user by referring to the user information storage unit, and providing the user with the Web page containing the information of the electronic mail when judging that it is determined in the browse determining step, after searching for the transmission record information from within the user information storage unit, that the user does not browse the information of the electronic mail.

9. The information processing method according to claim 6, wherein the Web page providing step includes, when receiving the access from the user determined in the browse determining step to have browsed the information of the electronic mail, providing the user with a Web page containing none of the information of the electronic mail.

10. A recoding medium recorded an information processing program for making a computer execute:
a browse determining step of determining whether or not a user to whom an electronic mail is addressed browses information of the delivered electronic mail by referring to a user information storage unit stored with at least an electronic mail address of the user in information about the registered user; and
a Web page providing step of receiving an access from the user determined in the browse determining step not to have browsed the information of the electronic mail, and providing a Web page containing the information of the electronic mail to the user.

11. The recoding medium recorded the information processing program according to claim 10, wherein the browse determining step includes, if applied to at least any one of a case where the user accesses a link destination attached to the delivered electronic mail and a case where Message Disposition Notification is sent from the address of the delivered electronic mail, determining that the user receiving the electronic mail has browsed the information of the electronic mail.

12. The recoding medium recorded the information processing program according to claim 10, further comprising a mail delivering step of referring to the user information storage unit and delivering the information by the electronic mail addressed to the electronic mail address stored in the user information storage unit,
wherein the mail delivering step includes, after delivering the electronic mail, getting the user information storage unit further stored with transmission record information defined as a record of delivering the electronic mail on a user-by-user basis,
the browse determining step includes, when determining that the user has browsed the information of the electronic mail, erasing the transmission record information of the user, which is stored in the user information storage unit, and
the Web page providing step includes, when the user accesses a Web page, checking existence or non-existence of the transmission record information of the user by referring to the user information storage unit, and providing the user with the Web page containing the information of the electronic mail when judging that it is determined in the browse determining step, after searching for the transmission record information from within the user information storage unit, that the user does not browse the information of the electronic mail.

13. The recoding medium recorded the information processing program according to claim 10, wherein the Web page providing step includes, when receiving the access from the user determined in the browse determining step to have browsed the information of the electronic mail, providing the user with a Web page containing none of the information of the electronic mail.
